(19) United States
(12) Patent Application Publication
(10) Pub. No.: US 2008/0065480 A1
(43) Pub. Date: Mar. 13, 2008

(54) SYSTEM FOR HANDLING AIR TRAFFIC DATA AND RELATED INFORMATION FOR SUPPLY TO CUSTOMERS

(76) Inventors: Daniel Baker, Houston, TX (US); Karl Lehenbauer, Houston, TX (US); David Cameron McNett, Austin, TX (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/530,357

(22) Filed: Sep. 8, 2006

(51) Int. Cl. G06Q 30/00

(52) U.S. Cl. 705/14

(57) ABSTRACT

A computer-implemented system and method for the processing and presentation of aviation information supported by targeted advertising is disclosed. At plurality of flight information is received over a digital network and is stored in at least a database. The database includes aviation information as well as advertisement messages. Upon receiving a user query, a server retrieves a result set from the database and couples it with at least one selected advertisement for presentation to the requesting user. In one form, the results may be presented to the user in the form of digital map having aircraft images and their altitude indicated by an offset shadow. Additionally, the visualization may show only a portion of the path of a flight in the event that multiple flights are displayed in order to preserve readability.

### FIELD OF THE INVENTION

The present invention generally relates to a system and method for receiving and processing flight tracking information for presentation to a plurality of users. More particularly, the present invention pertains to a flight tracking information service supported by targeted advertising accessible over the Internet.

### BACKGROUND

In 1995, the United States Federal Aviation Administration (FAA) made a wealth of minute by minute flight tracking information available for distribution to the public with the creation of the Aircraft Situation Display to Industry (ASDI) service. Through this service, flight tracking data is made available to several vendors who are subsequently able to provide information in a value-added format to their subscribers. The ASDI information includes the location, altitude, airspeed, origin, destination, estimated time of arrival and tail number or designated identifier of air carrier and general aviation aircraft operating on at least the corresponding IFR flight plans within U.S. airspace. General aviation VFR flights that include air traffic control flight following are often included. Traditional subscribers include flight departments, charter operators, limousine firms, airframe and power plant manufacturers, air carriers, fixed base operators (FBOs), research firms, and other users.

With the advent of this structure, a number of subscribers were able to obtain valuable flight information and increase the efficiency and reliability of their services. However, the FAA's wealth of flight tracking information had not truly made it into the hands of all interested parties. For example, the casual aviation enthusiast or pilot couldn't justify the large subscription fees in order to perform the occasional search of historical or current flight plans or destinations. Additionally, a user could not run any query of their choice to check on the flight of a loved one without submitting to a long registration process and/or setting up an account. The present invention solves a number of these problems as well as other problems present in the aviation information industry, as are illustrated in the descriptions that follow.

### SUMMARY

Various technologies and techniques are disclosed for receiving, processing, and displaying flight tracking information collected from a substantially real-time source. In one embodiment, a flight tracking information service is available over the Internet for no cost to users. The service is supported by targeted advertisements which are based upon the type of flight information the user is interested in.

In another embodiment, the service produces two dimensional digital maps to display the current location and previous flight path of a selected flight or flights in a unique way which increases the amount of information visually displayed and reduces on-screen clutter that can reduce readability.

Yet other forms, embodiments, objects, advantages, benefits, features, and aspects of the present invention will become apparent from the detailed description and drawings contained herein.

This summary is provided to introduce a selection of concepts in a simplified form that are described in further detail in the detailed description and drawings contained herein. This Summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one implementation.

FIG. 2 is a process flow diagram demonstrating one example of the steps involved in receiving and processing flight tracking information in one embodiment of the present system and method illustrated in FIG. 1.

FIG. 3 is a process flow diagram illustrating the steps for ensuring reliability of flight tracking data in a further embodiment of the present system and method illustrated in FIG. 1.

FIG. 4 is a process flow diagram illustrating the steps of receiving and responding to a user query in one embodiment of the present system and method illustrated in FIG. 1.

FIG. 5 is a diagrammatic view of a result displayed to a user in one form of the present system and method illustrated in FIG. 1.

FIG. 6 is yet another diagrammatic view of an alternate result displayed to a user in another form of the present system and method illustrated in FIG. 1.

### DETAILED DESCRIPTION

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

At any given moment there are likely to be more than 5,000 aircraft flying above the United States. In the course of a single day, more than 50,000 flights are completed from destination to destination. These numbers are growing at a staggering rate and will undoubtedly continue to rise as the need for commercial and private passenger flights increases coupled with the quickly growing number of aircraft used in the shipping industry.

Currently, systems exist which provide current flight tracking information. Users can obtain information such as the flight plan or status of an aircraft using identifiers such as its flight or tail number. This enables users to check up on flights of their family or friends, business owners to maintain the current status of their aircraft, and many other related service industries to predict departure/arrival times. Until applicants' invention, this information has been either difficult to obtain and utilize, or has been expensive. Applicants have incorporated many of the features disclosed herein into a fully functioning website at http://flightaware.com/, incorporated herein by reference.

Additionally, valuable information can be derived from historical flight information which is stored and presented to the user on demand. For instance, pilots and aircraft enthusiasts may wish to seek out the most commonly used routes by similar aircraft between two locations, or which airport is most commonly used for landing a certain size aircraft in a city having several airports. For any given search criteria, such an aircraft type or departure/destination airport, a wealth of information can be presented. Additionally, the user can be presented with other valuable information which is tailored to the users needs. The information presented may be based upon the type of aircraft of interest to the user, the selected departure airport or destination of the user, or services potentially needed by the user. The present invention is directed toward receiving and processing this wealth of aviation information and providing information of interest to the user in one or more aspects of the invention, but the present invention also serves other purposes in addition to these.

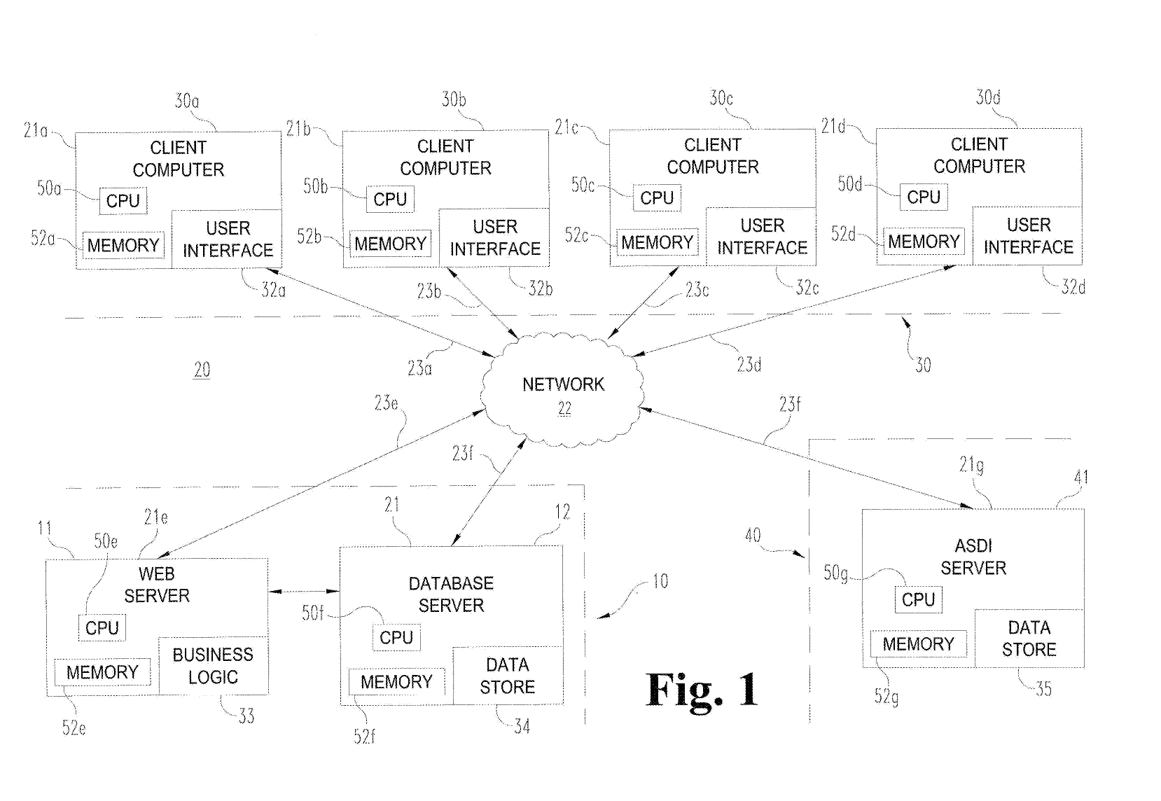

FIG. 1 is a diagrammatic view of computer system 20 of one embodiment of the present invention. In the illustrative embodiment, computer system 20 includes aviation information service 10, flight information provider 40, and client computers 30. Computer system 20 also includes computer network 22. Computer network 22 couples together a number of computers 21a-21g over network pathways 23a-23g, respectively. More specifically, system 20 includes several servers, namely Web Server 11 and Database Server 12 of aviation information service 10, and ASDI Server 41 of flight information provider 40. System 20 also includes client computers 30a, 30b, 30c, and 30d (collectively 30). While computers 21a-21g are each illustrated as being a server or client, it should be understood that any of computers 21a-21g may be arranged to include both a client and server. Furthermore, it should be understood that while seven computers 21a-21g are illustrated, more or fewer may be utilized in alternative embodiments. Preferably, service 10 includes a collection of Web servers 11 for receiving, processing, and responding to user queries.

Computers 21a-21g include one or more processors or CPUs (50a, 50b, 50c, 50d, 50e, 50f and 50g, respectively) and one or more types of memory (52a, 52b, 52c, 52d, 52e, 52f and 52g, respectively). Each memory 52 preferably includes a removable memory device. Each processor 50 may be comprised of one or more components configured as a single unit. When of a multi-component form, a processor 50 may have one or more components located remotely relative to the others. One or more components of each processor 50 may be of the electronic variety defining digital circuitry, analog circuitry, or both. In one embodiment, each processor 50 is of a conventional, integrated circuit microprocessor arrangement, such as one or more OPTERON processors supplied by ADVANCED MICRO DEVICES Corporation of One AMD Place, Sunnyvale, Calif. 94088, USA.

Each memory 52 (removable, fixed or both) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types, or other types not included in the above list. Also, each memory may be volatile, nonvolatile, or a hybrid combination of volatile and nonvolatile varieties.

Although not shown to preserve clarity, one or more of computers 21a-21g may be coupled to a display and/or may include an integrated display. Computers 21a-21g may be of the same type, or a heterogeneous combination of different computing devices. Likewise, displays may be of the same type, or a heterogeneous combination of different visual devices. Although again not shown to preserve clarity, each computer 21a-21g may also include one or more operator input devices such as a keyboard, mouse, track ball, light pen, and/or microtelecommunicator, to name just a few representative examples. Also, besides a display, one or more other output devices may be included such as a loudspeaker or printer. Various display and input device arrangements are possible.

Computer network 22 can be in the form of a wireless or wired Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers like computers 21a-21g can be coupled together by computer network 22.

In one embodiment, system 20 operates at one or more physical locations. Web Server 11 is configured as a web server that hosts application business logic 33 for an aviation information engine, Database Server 12 is configured as a database server for storing aviation information provided by ASDI Server 41, and at least one of client computers 30a-30d are configured for providing a user interface 32a-32d, respectively, for accessing the aviation information service 10. Preferably, Database Server 12 maintains at least one year of historical flight tracking information, and most preferably maintains at least three years. In a further form, Database Server 12 maintains data store 34 as a memory-resident database to provide more advanced searching functionality and minimize response times. User interface 32a-32d of client computers 30a-30d can be an installable application such as one that communicates with Web Server 11, can be browser-based, and/or can be embedded software, to name a few non-limiting examples.

In one embodiment, software installed locally on client computers 30a-30d is used to communicate with Web Server 11. In another embodiment, Web Server 11 provides HTML pages, data from web services, and/or other Internet standard or company proprietary data formats to one or more client computers 30a-30d when requested. One of ordinary skill in the art will recognize that the term web server is used generically for purposes of illustration and is not meant to imply that network 22 is required to be the Internet. As described previously, network 22 can be one of various types of networks as would occur to one of ordinary skill in the art. Database (data store) 34 on Database Server 12 can store data such as flight tracking information, departure/arrival notices, flight plans, historical flight information, aircraft information, and/or advertisement messages to name a few representative examples.

In the illustrative embodiment, flight tracking information is received from ASDI Server 41 which is at least one server that is a part of the Aircraft Situation Display to Industry Service (ASDI) provided by the Federal Aviation Administration (FAA). The feed provided by the ASDI service may be in real time or delayed, such as subject to a five minute delay. Connections to the feed are established in a structured format according to Aircraft Situation Display to Industry: Functional Description and Interface Control Document (available at http://www.fly.faa.gov/ASDI/asdi.html) which is herein incorporated by reference in its entirety.

Typical applications of system 20 would include more client computers like computers 30a-30d at more physical locations, but only four have been illustrated in FIG. 1 to preserve clarity. Furthermore, although two servers 11 and 12 are shown, it will be appreciated by those of ordinary skill in the art that the one or more features provided by Web Server 11 and Database Server 12 could be provided by the same computer or varying other arrangements of computers at one or more physical locations and still be within the spirit of the invention. Farms of dedicated servers, a single proprietary system, and/or a Storage Area Network (SAN) could also be provided to support the specific features if desired. In the illustrative embodiment, in order to flexibly handle the large quantity of flight information received by service 10, Database Server 12 includes a relational database, such as SQL, as in known to one of skill in the art.

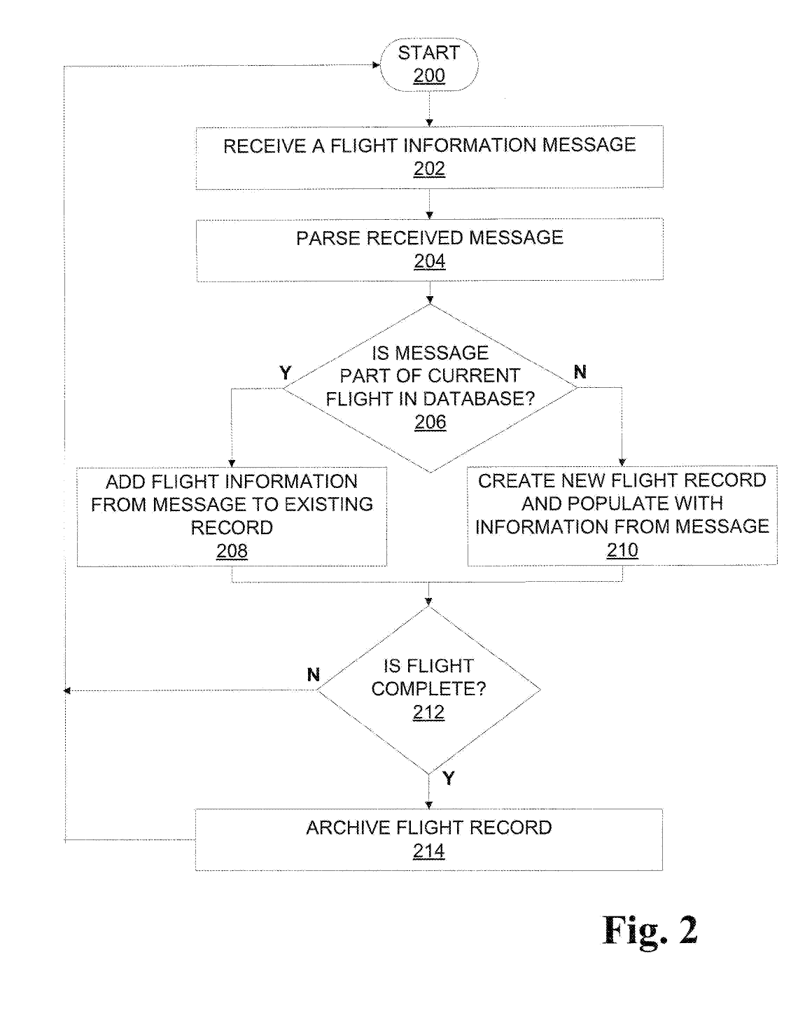

Turning to FIG. 2, with continued reference to FIG. 1, a flowchart illustrating the process of receiving and handling flight information is illustrated. The process begins at start point 200 with the service 10 receiving a flight information message (stage 202) from ASDI server 41. In one form, the flight information messages are received and processed by Database Server 12. In other forms, various other servers may process the data prior to entry into the data store 34. The flight information messages may be of a variety of different types, with each type providing various fields of information. Shown below are a few representative examples of the type of messages received by Database Server 12:

| Message Type: | Content: |
|---|---|
| NAS AF | revised flight plan data whenever |
| | a flight plan is amended |
| NAS AZ | arrival data for all eligible |
| | arriving flights |
| NAS DZ | departure message |
| NAS FZ | initial flight plan data |
| NAS RZ | cancellation data |
| NAS TZ | flight position updates |
| NAS UZ | ARTCC flight plan information |

Upon arrival, the flight information message is identified and assigned a type based upon the established formats provided by the ASDI service. Once the type of the message is identified, the message is parsed (stage 204) and the data is converted into a suitable format for insertion into Database Server 12. In one form, stage 204 may include the decoding of a message, the conversion of binary numbers to standard integers, the conversion of characters into words, and any other data conversion that may be required based upon the format of the received message and the format of the desired information for subsequent handling.

Once the contents of the message are obtained, service 10 identifies whether or not the message relates to an existing flight in the data store 34 (stage 206). If an existing flight record is found to which the contents of the message relate, the contents of the message are coupled with the existing information about the flight and the flight entry is updated (stage 206). In the event that the message does not relate to an existing flight, a new flight record is established and populated with the contents of the message (stage 210).

After a flight record is updated in stage 208 or created in stage 210, the service 10 determines if the flight is complete (stage 212). In the illustrative embodiment, typically a flight is marked complete upon the receipt of an arrival (NAS AZ) or cancellation (NAS RZ) message. In a further form, the service 10 may attempt to predict the arrival of a flight based upon a set of circumstances which may indicate that a flight has completed despite the absence of an arrival message. For example, if a flight record indicates that a flight has recently dropped below radar coverage near its destination proximate to its scheduled arrival time, the service 10 may shortly thereafter enter an arrival message to eliminate the problem of frequent arrival message failure by the ASDI service. In either event, when the flight is determined to be complete the service 10 archives the flight by compacting the flight record to minimize storage requirements going forward (stage 214) and awaits receipt of another flight information message. It shall be appreciated, that any number of flight information messages may be processed in parallel by service 10 and that FIG. 2 is simply illustrative of the sequential path of processing for a single flight information message.

Despite the level of sophistication of the ASDI service and the thousands of data collection points and radar terminals, as with any voluminous data source the service is prone to error. When providing real-time or substantially real-time information based upon this volume of data to a vast customer base, a single errant position may have a rather large impact. For instance, the mapped path of a flight may be terribly skewed by one errant position which may be thousands of miles off course. In a further form, the service 10 analyzes the reasonableness of each flight information message in order to combat spurious flight information messages from being included in data store 34. Data points determined to be unreasonable can be rejected from a component of data supplied to users.

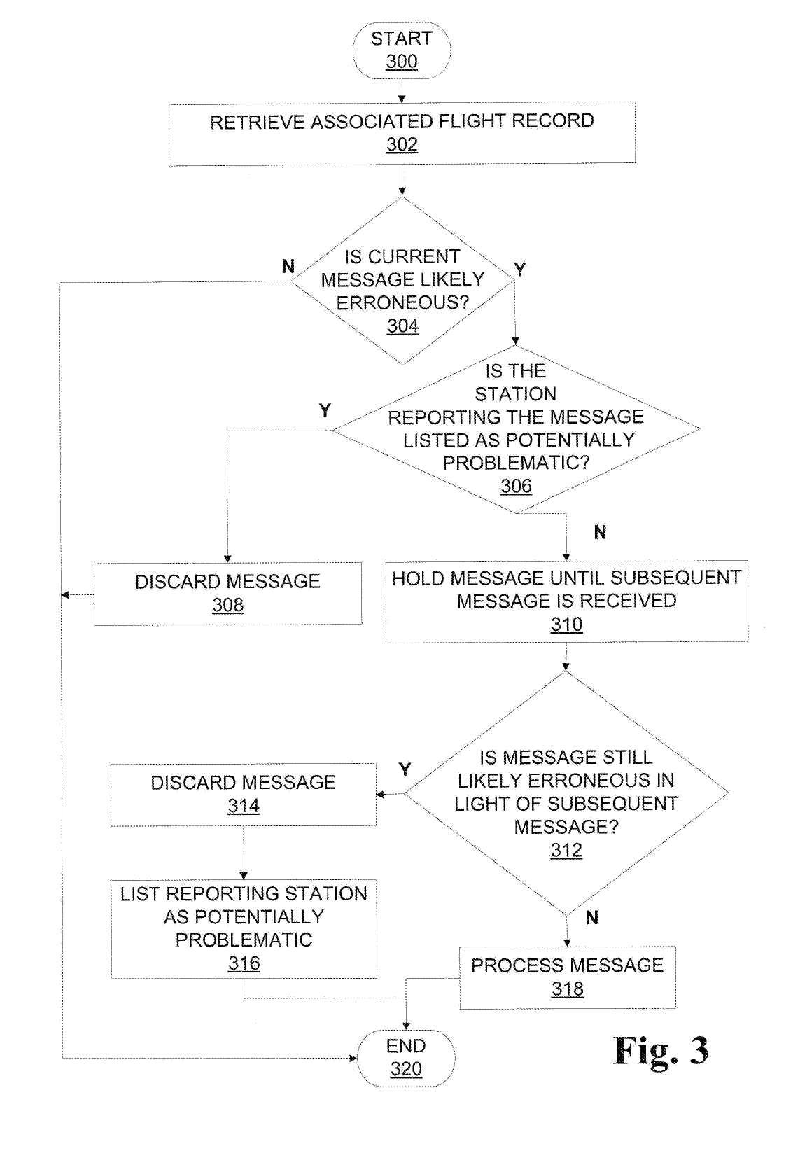

Turning to FIG. 3, the process for analyzing a flight information message for accuracy prior to entry into a flight record is illustrated. The process begins at start point 300 with the service 10 taking a received flight information message and retrieving any information associated with its particular flight (stage 302). This information may include prior flight positions, flight plan information, destination, heading, speed and/or altitude to name just a few representative examples. The service 10 then determines, using the prior flight information, if the current message is potentially erroneous (stage 304). In one form, the message is evaluated based upon how large the deviation is between a reasonably expected message and the content of the actual message received. For example, if the message contains a flight position that is 1000 miles from the closest previous flight positions then the message is likely to be incorrect. As another example, if a flight heading northwest and destined for Seattle, Wash., a message indicating a southeast heading of 120 degrees may be unlikely mid-flight. In a further form, the service 10 may assign a score to the message to indicate its divergence from an anticipated message. A threshold is then either statically set or dynamically modified to mark each message as erroneous or not. If the message is determined to be plausible, and not erroneous, then the process ends at end point 320 and the message is subsequently processed as described above.

In the event the message is indeed determined to be erroneous, the service 10 then checks the reporting station responsible for the message against a historically populated list of potentially problematic stations (stage 306). If the reporting station is included in this listing, then the message is discarded in stage 308. If the reporting station is not in the list, then the message is held pending the arrival of a subsequent message concerning the same flight (stage 310). Once the subsequent message is received, preferably from a different reporting station, the potentially erroneous message is again analyzed for plausibility (stage 312). If the message is again determined to be erroneous based upon this additional piece(s) of flight information, then the message is discarded in stage 314. Additionally, the reporting station associated with the erroneous message is added to the list of potentially problematic reporting stations in stage 316. If the message is validated using the additional flight information, the message is cleared and subsequently processed (stage 318) as described above. The process ends at end point 320. As flight information data is continuously processed by service 10, user queries are also accepted by Web Server 11.

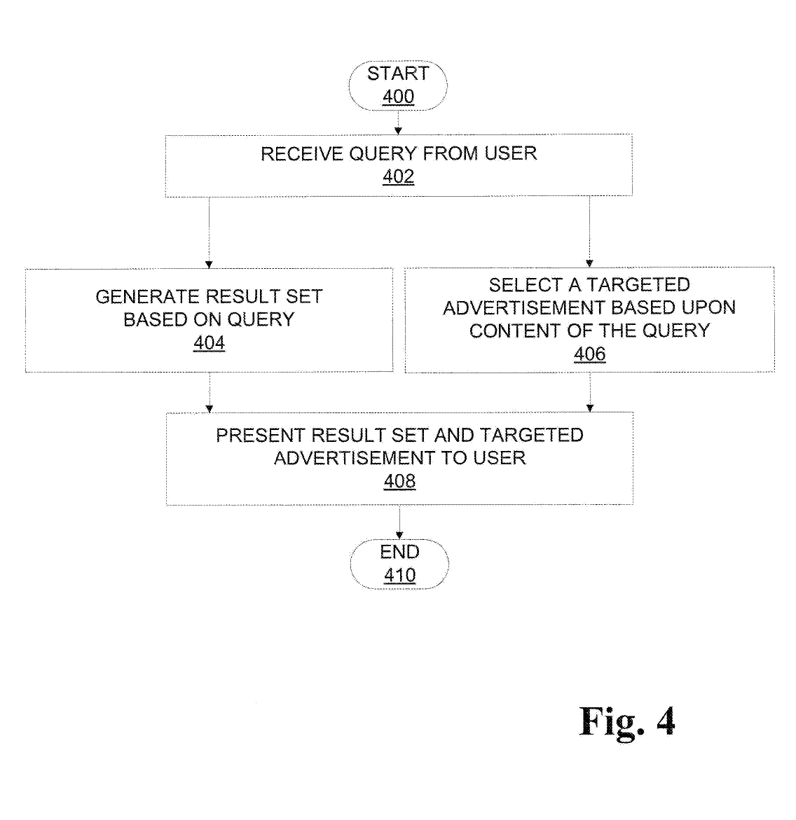

Turning to FIG. 4, with continued reference to FIG. 1, the process for receiving, processing, and responding to a user query is illustrated. The process begins at start point 400 with the user submitting a query (stage 402) to the aviation information service 10 using a web interface and a predetermined structured format. The user query may include either a single term or a variety of terms in combination. These terms may include flight number, tail number, departure time, departure location, arrival time, arrival location, altitude, air speed, proximity to a specific location, and/or the class of airspace (whether uncontrolled Class G, or controlled Class A, B, C, D or E), as well as weather related conditions such as wind speed and direction, temperature, barometric pressure, density altitude, measured ceiling, cloud tops, precipitation, visibility, status of weather as to IFR, VFR or MVFR, to name a few examples. In a further form, the user may specify a desire to search either all, current, or completed flights in order to target the information desired. For example, a pilot who owns a Cessna 310 may wish to search all completed Cessna 310 flights between New York and Boston in which the wind speed was above 20 mph in an easterly direction and visibility was over 3 miles. The pilot may then make a more informed decision concerning his flight plan for the same trip and similar weather conditions.

Once the query is received by service 10 at Web Server 11, the query is parsed and executed upon the database of current and historical flight information stored in data store 34. A result set is generated (stage 404) which may include a plurality of flights which closely match the query submitted by the user. In further forms, proximity searching is enabled to increase results in the event of a relatively small number of hits. The magnification of the map can be adaptively adjusted to include the selected number of hits over a wider space, to the extent permitted by the query results. The result set may be sorted based upon a relevancy score of any other criteria selected by the user either prior to of after the presentation of the results.

Additionally, in one form, at least one advertisement message is selected based upon the content of query submitted by the user (stage 406). The content of the query may include the terms submitted by the user as well as the listing of items of interest to that user, as discussed herein, as just a few representative examples. Service 10 maintains a collection of indexed advertisement messages in data store 34 for presentation to the users. Service 10 then attempts to match an advertisement to a received query based upon its content. For example, if a user submits a search for a commercial flight into Louisville, Ky., a listing of local parking lots or hotels may be displayed. If a user submits a query for historical Cessna flights, an advertisement message for Cessna repair or parts services may be displayed. If the user has a specific airport in his interest list, advertisements for services at that airport may be selected. In this manner, a user is presented with advertisements which are directly targeted towards the user's needs and advertisers are not wasting their efforts on users who are unlikely to be interested in their products and services. In a further form, the user of service 10 may create an account, and historical searching tendencies may be recorded to further increase advertisement selection accuracy. It shall be understood that separate from the selection of an advertisement by service 10, the result set that the user seeks in his or her query is generated independent thereof, and may be generated before, after, or concurrently with the selection of an advertisement message.

Once the result set and advertisement message(s) are selected, both are presented to the user in a convenient form via their web browser (stage 408). The user is able to interact with the result set by sorting the results, clicking on individual results to obtain more information, or refine their query. Additionally, the user may click on advertisements to be taken to a resource for further information such as the web site of the advertiser. In a further form, the identified best result is initially displayed to the user in visual form. The query process ends at end point 410.

In an additional form, the service 10 allows the user to submit a listing of identified items of particular interest to the user. For example, the list may include specific airports, flight numbers and/or aircraft numbers. Upon the submission of a query by the user, the service 10 utilizes the specified items of interest in order to produce a more personalized result set. The listing of items of interest may be used to supplement subsequent queries submitted by the user in one form. Of particular note, the service 10 retains this list in relation to the remote user for use in subsequent sessions, unless modified or cancelled or disabled by the remote user.

This is very useful to users who have a narrow set of criteria for the results they typically desire. For example, a pilot of a Cessna may simply not be interested in O'Hare airport, or may not be interested in the commercial flight traffic surrounding Chicago. By creating an interest list with one or more small airports surrounding Chicago, the service is able to easily filter out the irrelevant aviation information that would otherwise have likely flooded the result set for the user. Once the list is established, a simple search for Chicago and Cleveland would likely show only traffic between the smaller airports of Chicago and Cleveland that meet the subsequent query conditions, such as aircraft type. Thus the user can display only the flights the user has a general interest in. In the event the user later desires a broader perspective, the interest list searching feature in service 10 may be selectively modified, cancelled or disabled.

In one embodiment, the service 10 requires the user to log-in to the service in order to identify the user and enable searching based upon a specified interest list. Additional forms of user identification, such as cookies, may also be utilized. In one form, when a query is received from a user, a pre-existing listing of items of interest is incorporated into the query to form a customized query which is better suited to obtain the results desired by the user. Therefore, the user is able to define the search field in general terms with a listing and subsequently search that field without repetitively, manually entering those terms into each new query.

In the alternate form, when a query is received having an associated interest list, the service 10 may subsequently filter a result set obtained as a result of executing the query as received in a variety of ways. In one form, the system 10 highlights results which relate to the interest list. In a similar form, the service 10 sorts the list, with the results related to the interest list being included at the top. In third form, the service 10 supplies a result set to the user having only the results which are consistent with the interest list.

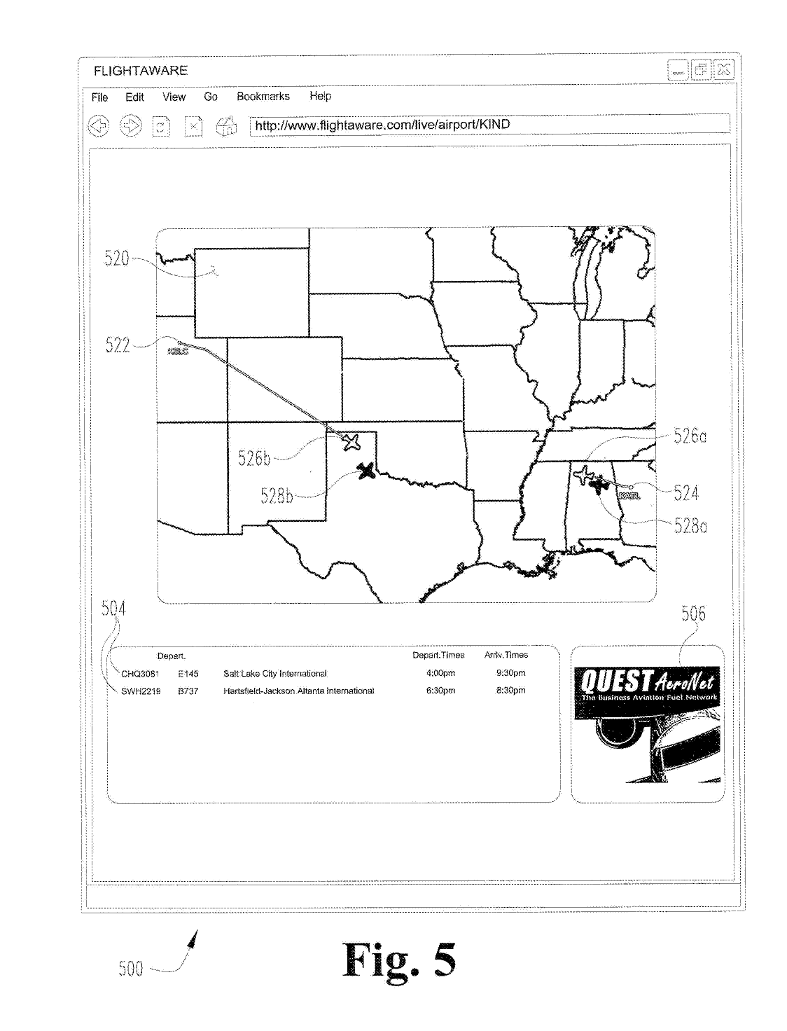

The collection and selection of aviation information described above is coupled with the following displays in the illustrative embodiment. FIG. 5 illustrates a representative web-page presented by service 10 in response to a specific commercial flight query. In this illustrative example, the query requested all current flights between Atlanta, Ga. and Salt Lake City, Utah. The result is displayed on web page 500 having main display portion 502, result display portion 504, and advertisement portion 506. Main display portion 502 includes a two-dimensional electronic map 520 which may be a standard map, a topographical map, a political map, an IFR or VFR aeronautical chart, an aerial photography map, or any other type of map or combination of maps or overlays known to one of skill in the art. The map includes airports 522 and 524. The current position of each flight is indicated by aircraft image 526a and 526b which may be an image of the type of aircraft associated with the flight. In addition, each aircraft is oriented to properly indicate the heading of the aircraft in flight.

Additionally, in one form, the altitude of the aircraft is visually indicated using a shadow 528a and 528b below the respective aircraft 526. The amount of offset of the shadow 528 from the aircraft 526 varies directly with the current altitude of the aircraft. In this example, it can readily be determined from the shadow offset that aircraft 528a, having altitude 30,000 ft, is considerably higher in altitude than aircraft 528b, which is currently at 10,000 ft. In the event the user selects a flight from the result set, the flight is highlighted on the main display portion 502. In a further form, the display portion 502 may present an accelerated playback of the flight path up to its current point.

Additionally, the result portion 504 displays several key pieces of information concerning the results identified by the service 10 based on the user submitted query. In this example, the two current flights are displayed along with identifying information, current airspeed, current altitude, flight time, and estimated flight time remaining. The result display portion 504 may also include historical results and/or related results.

Finally, in the illustrated embodiment, advertisement portion 506 displays at least one advertisement message 560 which is targeted to the user based upon the content of the query. In this case, advertisements may be for airport parking, local hotels, transportation services, or restaurants to name just a few representative examples.

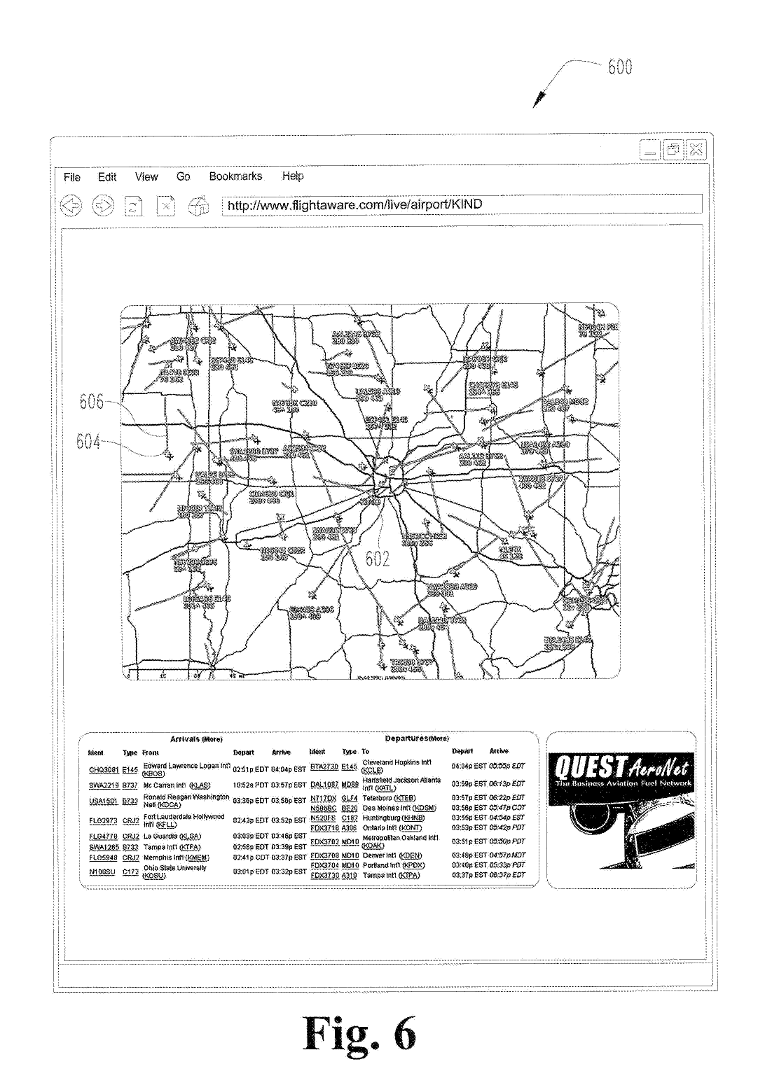

Turning to FIG. 6 yet another representative web-page presented by service 10 is illustrated. FIG. 6 shows a display presented in response to a query concerning a specific airport, IND, the Indianapolis International Airport, in this example. The result is displayed on web page 600 again having a main display portion, result display portion, and advertisement portion. The main display portion again shows a map including the selected airport 602. The current positions of all flights in the area are represented by aircraft images, such as aircraft 604. The service 10 selects a portion of a map surrounding the designated airport so that only a selected number of aircraft are displayed in order to increase readability. For example, the service 10 may set a ceiling of 50 aircraft and display a zoomed portion of the map such that only 50 or less aircraft are displayed. Typically, the designated airport is centered on the portion of the map displayed. In other forms, the user may designate the maximum, minimum, or exact number of aircraft to display in order to customize the display to their needs. Additionally, the user may designate the type of aircraft to display so that only aircraft of a certain type, such as commercial, private, arrival, or departure are displayed.

Additionally, in a further form, each aircraft is oriented to properly indicate the heading of the aircraft in flight and includes a line, such as line 606, showing the recent flight path of the aircraft. Preferably, the line is smoothed to approximate the flight path of the aircraft between positions. In one form, the flight path preferably includes less than 200 miles of the path so as not to clutter the screen when multiple aircraft are displayed simultaneously. More preferably, less than 100 miles of the path are displayed, and most preferably between 5 and 50 miles are displayed. Additionally, in an alternate form, the path may display only a set amount of the flight time, such as 10 minutes or less, or preferably 5 minutes or less, thereby indicating the airspeed of the flight relative to other illustrated flights. Still further other parameters may be used to determine the length of the displayed line, such as a combination of speed, time, and aircraft type. The line may be widened or lengthened, for example, for heavy planes, to reflect possible wake turbulence, or merely to visually give an illustrative weight component to the display. The line may be wider near the aircraft than further away. Additionally, the line may be colored or otherwise modified to indicate other attributes of the flight such as if the aircraft is climbing, descending, speeding up, slowing down, etc.

In a still further form, departing and arriving flights of the designated airport may be independently colored or otherwise distinguished from those which are merely traversing the airspace surrounding the designated airport. For example, arriving flights may be yellow, departing flights green and traversing flights blue. Because there can be periodic errors in the data, and because individual straight line segments between dots are not as aesthetically pleasing, the system has software to make the aircraft path line appear as a curve made smooth to approximately connect said collection of positions deemed to be reliable.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

What is claimed is:

1. A method comprising the steps of:
maintaining a database storing aviation related information;
receiving flight tracking information from a substantially real-time source;
storing at least a portion of said flight tracking information in a formatted form in said database;
receiving a query from a user through a digital network;
selecting a result set from said database based on said query;
selecting at least one targeted advertisement message based upon the content of said query rather than the non-query portion of said result set; and
presenting said result set to the user along with said targeted advertisement message using said digital network.

2. The method of claim 1, wherein said query contains at least one search criteria selected from the group consisting of aircraft type, flight route, airport facility, destination, and origin.

3. The method of claim 2, wherein said advertisement message is selected using said search criteria.

4. The method of claim 1, wherein said substantially real-time source is the FAA Aircraft Situation Display to Industry service.

5. The method of claim 4, wherein said flight tracking information is delayed by less than approximately 5 minutes.

6. The method of claim 5, wherein said flight tracking information is delayed by less than approximately 10 minutes.

7. The method of claim 1, wherein said maintaining encompasses at least one year of flight tracking information.

8. The method of claim 7, wherein said maintaining encompasses at least three years of flight tracking information.

9. The method of claim 1, wherein said digital network comprises the Internet.

10. The method of claim 1, wherein said presenting includes displaying at least a portion of said result set on a web-page.

11. The method of claim 1, wherein said flight tracking information includes information related to at least one aircraft on the BARR list.

12. A method comprising the steps of:
receiving a stream of messages containing flight tracking information;
selecting a subset of messages of said stream associated with a particular aircraft;
identifying a potentially inaccurate message containing position information in said subset;
removing said message from said subset; and
constructing a flight path associated with said aircraft based at least upon said subset.

13. The method of claim 12, wherein said identifying includes calculating a score which indicates the amount of deviation from an expected flight path; and
comparing said score to a threshold in order to determine if said message is potentially inaccurate.

14. The method of claim 13, wherein said threshold is lowered in the event said message is attributable to a reporting station which has a history of problematic reporting.

15. The method of claim 12, wherein said stream of messages is received from the FAA Aircraft Situation Display to Industry service.

16. A method comprising the steps of:
plotting a flight path associated with an aircraft on a two-dimensional electronic map based on substantially real-time flight tracking information; and
displaying only a portion of said flight path corresponding to the most recent locations of said aircraft during said flight path.

17. The method of claim 16, wherein said flight path is a line connecting a collection of positions of said aircraft indicated by said flight tracking information.

18. The method of claim 16, wherein said portion includes only positions reported during approximately the last 10 minutes or less.

19. The method of claim 18, wherein said portion includes only positions reported during approximately the last 5 minutes or less.

20. The method of claim 16, wherein said portion includes from more than 1 to less than 200 miles.

21. The method of claim 20, wherein said portion includes from more than 5 to less than 100 miles.

22. The method of claim 21, wherein said portion includes from more than 10 to less than 50 miles.

23. The method of claim 17, wherein said line is a curve made smooth to approximately connect said collection of positions.

24. A method comprising the steps of:
plotting a current position of a plurality of aircraft on a two-dimensional electronic map including at least one airport based on flight tracking information; and
displaying only a portion of said map which includes said airport and no more than a selected number of aircraft from said plurality.

25. The method of claim 24, wherein said airport is centrally located on said map.

26. The method of claim 24, wherein said selected number of aircraft is acceptable to prevent overcrowding of said map.

27. The method of claim 24, wherein said selected number of aircraft is input by the user.

28. The method of claim 24, wherein said plurality of aircraft all have the same type.

29. The method of claim 28, wherein said type is selected from the group consisting of commercial, private, arrivals, and departures.

30. The method of claim 28, wherein said type is an airplane class.

31. The method of claim 28, wherein said type is a specific airplane model.

32. The method of claim 24, wherein said portion is a zoomed view of said map.

33. A method comprising the steps of:
displaying the current position of an aircraft as a symbol on a two-dimensional electronic map based on flight tracking information;
displaying a drop shadow of said symbol offset from said symbol by an amount which varies according to the altitude of said aircraft.

34. The method of claim 33, wherein said symbol is an image of an aircraft.

35. The method of claim 34, wherein said image is a representative image of the particular type of said aircraft.

36. The method of claim 33, wherein the size of said image and drop shadow varies relative to the size of said aircraft and the amount of said offset is approximately proportional to the altitude of said aircraft above ground level.

37. A system comprising:
a first server maintaining a memory resident database containing flight tracking information spanning at least one month continuously updated with information received from a substantially real-time source; and
a web server capable of receiving a request for flight information based on a query from a remote user over a digital network, communicating with said first server to execute said query, and sending a formatted result set to the user over said network.

38. The system of claim 37, wherein said digital network comprises the Internet.

39. The system of claim 37, wherein said flight tracking information spans at least one year.

40. The system of claim 37, wherein said flight tracking information spans at least three years.

41. A method comprising the steps of:
maintaining a database storing aviation related information;
receiving flight tracking information from a substantially real-time source;
storing at least a portion of said flight tracking information in said database;
first receiving from a remote user an identification of one or more of the following items of interest to the remote user:
one or more airport identifiers,
one or more aircraft numbers, and/or
one or more flight numbers,
retaining said remote user's item identification in association with the identity of said remote user for the remote user's use in a subsequent session following the remote user disconnecting from the remote connection, and thereafter reconnecting;
receiving a query from said remote user through said digital network following reconnection in a later session;
selecting a result set from said database based on both said identified item(s) from the prior session and said query in said later session;
presenting said result set to said remote user over said digital network during said later session.

42. The method of claim 41, wherein said query is received at least one day after said identified items were received.

43. The method of claim 41, wherein said selecting involves executing a master query comprised of said identified items and said query in combination within said database.

44. The method of claim 41, wherein said selecting involves executing said query within said database to generate an intermediate set and subsequently filtering said intermediate set using said identified items to achieve said result set.

45. The method of claim 44, wherein said filtering includes highlighting in said result set the results related to at least one of said identified items.

46. The method of claim 44, wherein said filtering includes removing from said result set the results not related to at least one of said identified items.

47. The method of claim 41, wherein said substantially real-time source is the FAA Aircraft Situation Display to Industry service.

48. The method of claim 41, wherein said maintaining encompasses at least one year of flight tracking information.
